(19) United States
(12) Patent Application Publication
(10) Pub. No.: US 2005/0244315 A1
(43) Pub. Date: Nov. 3, 2005

(54) Solid product dissolver and method of use thereof

(76) Inventors: Michael D. Greaves, Bensenville, IL (US); Bruce D. Bedford, Naperville, IL (US); Stefan Munch, Chicago, IL (US); William J. Stankiewicz, Lockport, IL (US); James L. Copeland, Apple Valley, MN (US)

Correspondence Address: Nalco Company;Patent & Licensing Department, 1601 W. Diehl Road, Naperville, IL, 60563-1198, US

(21) Appl. No.: 10/836,386

(22) Filed: Apr. 30, 2004

(51) Int. Cl. B01D 11/02

(52) U.S. Cl. 422/264; 422/274; 422/276

(57) ABSTRACT

The present invention provides a device for producing a water treatment solution from a solid chemical block for distribution into a water system selected from the group comprising an institutional water system and an industrial water system. The device includes a housing to contain the solid chemical block. A fluid, preferably water at ambient temperature, is introduced into the housing to dissolve the block and form a liquid solution that may then be dispensed into either an institutional water system or an industrial water system. A method of dispensing the liquid solution with the device is also provided.

### FIELD OF THE INVENTION

The present invention generally relates to devices and methods for producing a liquid treatment solution from a solid chemical block of a treatment product for dispensing into a water system.

### BACKGROUND OF THE INVENTION

Dispenser systems are commonly used to add chemicals for the treatment of water systems located in institutional and in industrial settings. A dispenser system typically delivers a treatment product to control undesirable phenomena such as scaling, corrosion, fouling and microbiological growth within the water system. The treatment product is typically prepared by applying a fluid, such as water, to a solid chemical material in the form of a powder, briquette, or block, to formulate a liquid solution from the solid material. The liquid solution is subsequently delivered into the water system.

Conventional systems, however, are unsuitable for many smaller scale water systems in institutional and industrial facilities. Many institutional and industrial settings simply lack the space or capacity to adequately secure current dispensing systems that are designed for permanent attachment to a facility. In addition, conventional dispensing systems typically involve various system controls (e.g., temperature control, fluid flow rate control, fluid delivery regulation) for the fluid, namely water, used to produce the liquid chemical solution. This unfortunately requires operator attention as well as the additional requirement of access to an external power source—resources that may not be readily available in institutional and industrial facilities.

A need therefore exists for a safe, effective, and low-maintenance device that is readily moveable for producing a liquid solution from a chemical solid for delivery into an industrial water system. A need further exists for a chemical composition that provides a stable and effective water treatment solution when used with common tap water at ambient temperature.

### SUMMARY OF THE INVENTION

Pursuant to an embodiment of the invention, a vessel for dispensing a chemical solution from a solid chemical block is provided. The vessel includes an inner surface that defines a chamber. A plurality of guide members are disposed along the inner surface in a spaced apart manner. The guide members position at least one chemical block within the chamber to form a gap between the inner surface of the chamber and the outer circumference of the block. A porous support member supports at least one chemical block in the chamber. A spray member located below the support member directs a spray in an upward manner along a vertical length of the inner chamber. The spray contacts a surface of the block to form a liquid solution.

In another embodiment of the invention, the vessel for producing a chemical solution from a solid chemical block has an inner surface defining a chamber. An annular sleeve having a tapered wall is disposed within the chamber. The tapered wall thereby forms a funnel-like passageway through the sleeve, the passageway having a diameter that decreases as the tapered wall extends from the inner surface radially inward and downward. A peripheral edge of at least one chemical block is placed in supportive contact with an inner surface of the tapered wall to expose a surface, typically a bottom surface, of the block. A spray member located below the sleeve directs a spray in an upward manner along a vertical length of the sleeve. The spray contacts a surface of the block to form a liquid solution. The tapered wall extends from the inner surface inwardly downward toward the spray member.

Furthermore, in another embodiment of the present invention, a device for producing a chemical solution from a solid chemical block is provided. The device includes a housing having an inner chamber and a porous support member within the housing for supporting the chemical block within the inner chamber. A fluid inlet introduces a fluid into the chamber and onto the chemical block to dissolve at least a portion of the chemical block and form a liquid solution. A container receives the liquid solution. The device also includes a sensing device for sensing the amount of liquid solution present in the container. The sensing device is in operative communication with the fluid inlet and directs the fluid inlet to introduce the fluid when the amount of liquid solution in the container is below a threshold level.

In another embodiment of the present invention, a device for producing a chemical solution from a solid chemical block is provided. The device includes a housing defining a chamber and a plurality of solid chemical blocks disposed within the chamber. A fluid inlet for introducing a fluid into the chamber is disposed on an inlet end of the housing. At least two of the blocks dissolve substantially contemporaneous from contact with the fluid to form a liquid solution containing the chemical or chemicals of the solid blocks. The device further includes an outlet member in fluid communication with the chamber for discharging the liquid solution from the chamber. The outlet member may be disposed on an end of the housing opposing the inlet end.

In yet another embodiment of the present invention, a device for producing a chemical solution from a solid chemical block is provided, the device having a housing which has a chamber and a solid chemical block disposed within the chamber. A fluid inlet for introducing a fluid into the chamber is located at a first end of the chamber. The fluid introduced into the chamber contacts the chemical block to dissolve at least a portion of the block to form a liquid solution. A fluid outlet for discharging the liquid solution from the chamber is located at an end opposite to the first end of the chamber. The opposing relation between the fluid inlet and the fluid outlet forms a fluid counterflow through the chamber.

In a further embodiment of the present invention, either an institutional or industrial facility is provided, with a water system requiring treatment, having a vessel with an inner surface defining a chamber. A plurality of spaced apart guide members disposed along the inner surface position the at least one chemical block to form a gap between the inner surface and a circumference of the block. A porous support member is disposed in the housing for supporting the at least one chemical block in the chamber. A water inlet located below the support member allows water to flow upward along a vertical length of the inner chamber. The water contacts a surface of one or more of the blocks to form a liquid solution. The facility also includes either an institutional water system or an industrial water system in fluid communication with the vessel. The liquid solution may be dispensed from the vessel into the institutional water system or the industrial water system to treat the water in the system.

The present invention also provides a method of dispensing a solid water treatment product into a water system selected from the group comprising institutional water system and industrial water systems is provided. The method includes:

(i) providing a housing having at least two solid chemical blocks containing the water treatment product disposed therein;

(ii) introducing a fluid into the housing;

(iii) contacting the at least two chemical blocks with the fluid to dissolve contemporaneously at least a portion of each of the at least two chemical blocks to form a liquid solution containing the water treatment product; and

(iv) dispensing the liquid solution into the industrial water system.

The solid chemical block can be a water treatment composition having a matrix component, a compacting component, a corrosion inhibiting agent, a yellow metal corrosion inhibitor, and a tracing agent. The composition may also include a dispersant and a scale inhibiting agent.

The prevent invention advantageously provides a moveable device for producing a liquid water treatment product from a solid chemical block. The device is easy to transport and assemble for operation. The device requires little or no maintenance to operate as no external energy source is required. The device may be completely gravity-driven. The solid chemical block may be composed to readily dissolve when contacted with common tap water at ambient temperature.

Additional features and advantages of the present invention are described in and will be apparent from the following Detailed Description of the Presently Preferred Embodiments.

### BRIEF DESCRIPTION OF THE DRAWINGS

FIG. 1 is a sectional view of a vessel for producing a solution from a solid chemical block in accordance with the present invention.

FIG. 2 is a top plan view of the vessel of FIG. 1.

FIG. 3 is a top plan view of another embodiment of the vessel of the present invention.

FIG. 4 is a sectional view of a vessel for producing a solution from a solid chemical block in accordance with another embodiment of the present invention.

FIG. 5 is a sectional view of a device for producing a chemical solution from a chemical block in accordance with another embodiment of the present invention.

FIG. 6 is a sectional view of another embodiment of the vessel of the present invention.

FIG. 7 is a sectional view of another embodiment of a device for producing a chemical solution from a chemical block in accordance with the present invention.

FIG. 8 is a sectional view of another embodiment of a device for producing a chemical solution from a chemical block in accordance with the present invention.

### DETAILED DESCRIPTION OF THE PREFERRED EMBODIMENTS

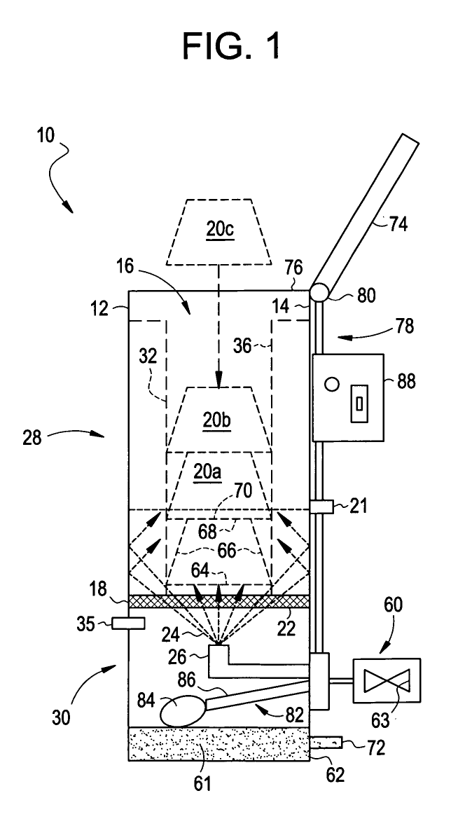

Referring to the Figures generally, where like reference numerals denote like structure and elements, and in particular to FIGS. 1-3, a vessel 10 for dispensing a chemical solution is shown in accordance with the present invention. Vessel 10 includes a housing 12 having an inner surface 14 that defines a chamber 16. Housing 12 may be annular in configuration and substantially vertically disposed and may be any suitable shape such as a cylindrical shape, for example. Housing 12 may be constructed of any suitable material which is capable of withstanding exposure to highly caustic and/or corrosive compounds and solution as is commonly known in the art. Housing 12 may be made of stainless steel, including modified stainless steel or an inert polymeric or plastic material. Housing 12 may be constructed of a transparent or translucent material permitting the contents of chamber 16 to be readily viewed by an operator.

A porous support member or screen 18 is mounted within inner chamber 16 to provide a substantially horizontal support surface for a solid chemical block 20. Screen 18 may be permanently or removably secured to inner chamber 16 as is commonly known in the art. Screen 18 may rest upon a circumferential flange (not shown) attached to inner surface 14 thereby permitting screen 18 to be readily removed from housing 12 for cleaning and maintenance. Screen 18 may also be supported by brackets, bars or any other fixture capable of holding Screen 18 in place. Screen 18 has a plurality of openings 22 that do not interfere with the impingement and contact of a fluid spray 24 onto chemical block 20 from a spray member or nozzle 26 disposed under screen 18.

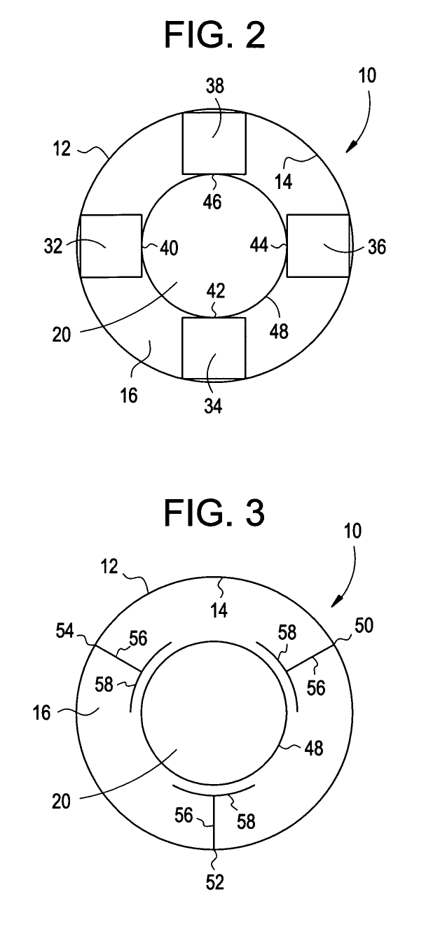

Screen 18 divides vessel 10 into an upper portion 28 and a lower portion 30. A plurality of guide members 32, 34, 36 and 38 extend along inner surface 14 in upper chamber portion 28 as shown in FIGS. 1 and 2. The guide members may be permanently or removably attached to either or both inner surface 14 or screen 18 as desired. Guide members 32, 34, 36 and 38 are spaced apart along inner surface 14 so as to position chemical block 20 in a generally central area of chamber 16. Chemical block 20 rests on a generally central area of screen 18 and is retained within upper chamber portion 28.

The guide members may extend along a portion of upper chamber portion 28 as shown in FIG. 1. Alternatively, the guide members may extend along the entire extent of upper chamber portion 28 from screen 18 to an upper edge 76 of housing 12. Guide members 32, 34, 36 and 38 may be made of the same or a different material as housing 12. As chemical block 20 may contact one or all of the guide members, the guide members may be composed of a material substantially inert to the composition of chemical block 20 such as stainless steel, modified stainless steel, or a polymeric material, for example. Alternatively, the guide members may extend the entire length of upper chamber portion 28.

Guide members 32, 34, 36, and 38 may be formed in any shape and/or size in order to position or otherwise situate chemical block 20 within a generally central area of upper chamber portion 28 and a generally central area of screen 18. FIG. 1. illustrates guide members 32, 34, 36, and 38 having a generally square cross sectional shape. Guide members 32, 34, 36, and 38 thereby form a gap between inner surface 14 and the outer circumference of chemical block 20 as shown in FIG. 2. It is understood that the guide members may have any suitable cross sectional shape including but not limited to polygonal, triangular, arcuate, circular, or elliptical. The size of guide members may be varied as dictated by the operational requirements of vessel 10. For example, guide members 32, 34, 36, and 38 each may have a respective inner surface 40, 42, 44, and 46 that contacts an outer edge 48 of chemical block 20. Alternatively, the guide members may be dimensioned so that substantially no contact occurs between surfaces 40, 42, 44, and 46 and outer edge 48. The skilled artisan will recognize that housing 12 may contain as few as two guide members or as many as six or more guide members without detracting from the scope of the present invention. All of the guide members may be formed into the vessel itself or they may be fabricated separately and added later.

In an embodiment of the present invention, guide members 50, 52, and 54 retain or otherwise position chemical block 20 within a generally central area of upper chamber portion 28 as shown in FIG. 3. Each guide member includes a support arm 56 in contact with inner surface 14 and a retaining member 58. Although each retaining member 58 is arcuate in shape in FIG. 3, the skilled artisan will appreciate that the retaining member may be any shape such as linear, for example. Guide members 50, 52, and 54 provide a gap between block outer edge 48 and inner surface 14. As is readily apparent from FIGS. 2 and 3, guide members 50, 52, and 54 cover far less area than guide members 32, 34, 36, and 38. Guide members 50, 52, and 54 thereby allow more area of block 20 to be exposed to fluid spray 24 when compared to the area of block 20 exposed when using guide members 32, 34, 36, and 38. This may be advantageous in high demand industrial applications whereby it is necessary to dissolve chemical block 20 quickly.

A fluid delivery system 60 is in fluid communication with nozzle 26 for delivering a fluid thereto as shown in FIG. 1. Fluid delivery system 60 includes a valve 63 and a fluid source (not shown). The fluid of the present invention may be any fluid such as a liquid or a combination of a liquid and a gas capable of dissolving chemical block 20 as commonly known in the art. The fluid may be water and may be aerated or a fluid mixture of compressed air and water, for example. The fluid water may be delivered under pressure to nozzle 26.

The fluid source may be any source of water such as water stored in a tank, water from a well, or water from a local or regional governmental water supply, for example. In an embodiment, the fluid source is a municipal water system. Thus, an advantage of the present invention is that the water used in the present invention requires no processing or treatment before being introduced into vessel 10. In addition, chemical block 20 may have a composition that permits ready dissolution upon contact with common tap water, such as water from a municipal water supply. Thus, chemical block 20 may readily dissolve upon contact with common tap water at ambient temperature. Ordinary tap water typically has a temperature in the range from about 1° C. to about 60° C. Hence, tap water in this temperature range may readily dissolve chemical block 20. This demonstrates an advantage of the present invention whereby vessel 10 may be readily connected to a supply of common tap water and operated without the use of a water temperature control system.

Housing 12 may be equipped with a chemical sensor 21 to sense when the amount of chemical block 20 drops below a threshold level. Chemical sensor 21 may then generate a signal when (e.g., a light or an audible alarm) alerting an operator to attend to vessel 10.

Nozzle 26 is positioned in lower portion 30 below screen 18 in order to upwardly deliver fluid spray 24 through screen 18 into upper vessel portion 28. Fluid spray 24 contacts chemical block 20 thereby dissolving the block. The dissolution of chemical block 20 forms a liquid solution 61 containing the dissolved chemical from chemical block 20. As fluid spray 24 continues to contact chemical block 20, droplets of the liquid solution form on chemical block 20 and drop through screen 18 into a container 62 positioned under screen 18. Liquid solution 61 collects in a lower section of vessel 10, otherwise a container 62 located in lower vessel portion 30.

The spray pressure in nozzle 26 can range anywhere from about 1 psi to about 100 psi, preferably from about 10 psi to about 30 psi and most preferably about 20 psi.

The positioning of chemical block 20 to form a space or a gap between inner surface 14 and block 20 with the guide members advantageously enables fluid spray 24 to contact a large area of the chemical block surface. As shown in FIG. 1, a portion of fluid spray 24 directly impinges a bottom surface 64 of chemical block 20. In addition, a portion of fluid spray 24 impinges inner surface 14 and is subsequently deflected into contact with chemical block 20. This deflected fluid spray may contact a side surface 66 of chemical block 20. The deflected fluid spray may even impinge and contact a top surface 68 of chemical block 20. The deflected fluid spray also may contact bottom surface 64. The chemical block may be centrally disposed to expose a greater area to both direct and indirect contact with fluid spray 24. A portion of fluid spray 24 may also be deflected off one, some or all of the guide members and subsequently contact chemical block 20 in a similar manner. Thus, provision of the guide members and the space between the block 20 and inner surface 14 advantageously permits a more rapid dissolution of the chemical block when compared to dispensing systems wherein only a single surface of a solid material is exposed to a fluid spray. Thus, vessel 10 is well adapted to service systems requiring high demand chemical treatment.

Housing 12 may be suitably adapted to contain a plurality of chemical blocks 20a, 20b and 20c as shown in FIG. 1. Similar to block 20, chemical blocks 20a, 20b, and 20c positioned in a generally central area of upper chamber portion 28 by guide members 32, 34, 36, and 38. The blocks are arranged in a substantially vertically stacked configuration wherein a bottom surface 70 of chemical block 20a is supported by top surface 68, the bottom of block 20b is support by the top of block 20a and so on.

The shape of chemical blocks useful in the instant claimed invention is limited only by the inner dimensions of chamber 16. As depicted in these figures chemical block 20 are generally depicted as being in a cylindrically trapezoidal shape. Other possible configurations include anything stackable, such as, but not limited to, truncated cones, prismatic cylinders, spheres, cubes and discs.

When fluid spray 24 is introduced into upper chamber portion 28, a portion of the spray may contact a surface of block 20a, 20b, or 20c. Fluid spray 24 may directly impinge and contact any of blocks 20, 20a-20c or may indirectly contact any of the chemical blocks by first impinging inner surface 24 and/or any or all of guide members 32, 34, 36, and 38 and subsequently impinging blocks 20, 20a-20c. One of ordinary skill in the art will recognize that the spray pattern and the delivery pressure of fluid spray 24 may be adjusted as desired to contact or wet one or more chemical blocks as desired.

In FIG. 1, there is an optional overflow port 35 depicted which is designed to allow for drainage of solution in the event of a valve failure causing solution to remain in the vessel instead of leaving the vessel through outlet port 72 as designed.

The present invention contemplates that vessel 10 may be an integral or otherwise self-sustaining unit that may be readily connected and disconnected to systems requiring chemical treatment. The self-containment of vessel 10 is advantageous as vessel 10 may be moveable or otherwise portable. Moveable means that system 10 is not permanently affixed to any support structure such as a building or other support foundation. Consequently, vessel 10 may be placed upon a wheeled base to become portable or may be mounted upon a lifting platform (e.g., a pallet) or the like thereby allowing lifting by a forklift or other any other type of lifting equipment to move vessel 10. Or wheels may be affixed to the bottom of vessel 10 and the vessel can then be wheeled where desired.

A key useful feature of the instant claimed invention is that vessel 10 is completely gravity-driven requiring no external power source for operation.

Container 62 includes an outlet port 72 for discharging liquid solution 61. Outlet port 72 is suitably adapted to be placed in fluid communication with a water system requiring chemical treatment as is commonly known in the art. Outlet port 72 may be placed in fluid communication with water system selected from the group comprising institutional water systems and industrial water systems.

Nonlimiting examples of suitable institutional water systems that may be treated by dispensing vessel 10 include hotels, hospitals, health care facilities, nursing homes, educational campuses and recreational facilities. Other water systems that come under the broad heading of “institutional water systems” include decorative fountains, bathing ponds, whirpool baths, swimming pools, water parks and theme park amusement facilities requiring large amounts of non-potable water.

Nonlimiting examples of suitable industrial water systems that may be treated by dispensing vessel 10 include cooling water systems, including open recirculating, closed and once-through cooling tower water systems; boilers and boiler water systems; petroleum wells, downhole formations, geothermal wells and other oil field applications; mineral process waters including mineral washing, flotation and benefaction; paper mill digesters, washers, bleach plants and white water systems; black liquor evaporators in the pulp industry; gas scrubbers and air washers; continuous casting processes in the metallurgical industry; air conditioning and refrigeration systems; industrial and petroleum process water; indirect contact cooling and heating water, such as pasteurization water; water reclamation and purification systems; membrane filtration water systems; food processing streams (meat, vegetable, sugar beets, sugar cane, grain, poultry, fruit and soybean); and waste treatment systems as well as in clarifiers, liquid-solid applications, municipal sewage treatment and industrial or municipal water systems.

By way of example and not limitation, vessel 10 can be from about 2 feet to about 7 feet in height. This compactness and the portability of vessel 10 makes vessel 10 ideally suited for small-volume industrial water systems, such as water systems servicing a single building or a single fountain, for example. The capability of vessel 10 to operate simply upon connection to a supply of tap water makes vessel 10 quite versatile and well-suited to be removably installed at a facility and operated with little or no human intervention.

Vessel 10 may include a cover 74 pivotally attached to an upper end 76 of housing 12 as shown in FIG. 1. Cover 74 contains substantially all fluid spray and airborne liquid solution within housing 12 during the spraying of block 20. In a closed position, cover 74 thereby serves as a safety device protecting nearby operators and the area surrounding vessel 10 from the caustic or corrosive chemical spray and/or spurious discharge of the liquid solution from the top of housing 12. When additional chemical blocks are to be added to system 10, cover 74 is moved to an open position providing access to chamber 16.

As a further safety measure, vessel 10 may be equipped with a detection device 78 for detecting the position of cover 74. Detection device 78 is configured to be in operative communication with a hinge member 80 and fluid delivery system 60. When cover 74 is in the open position, detection device 78 prevents fluid delivery system 60 from delivering fluid to nozzle 26. Correspondingly, when cover 74 is in the closed position, detection device 78 permits fluid delivery system to deliver fluid to nozzle 26. Detection device 78 may be mechanically or electrically actuated and may be in electrical or mechanical communication with valve 63 to regulate the flow of fluid through valve 63 as is commonly known in the art. Detection device 78 may be a mechanical switch, hinge, or pivot pin that moves a protruding member to block an opening mechanism of valve 61 as is commonly known in the art. A simple and reliable mechanical detection device may be used in keeping with the convenience, low maintenance and ease of use advantages of the present invention.

In the absence of a detection device, cover 74 may be secured with a lock and warning signs may be posted that say, “don't unlock this cover until the water is shut off”.

Vessel 10 may further include a sensing device 82 for sensing the amount of liquid solution present in container 62 as is commonly known in the art. Sensing device 82 is in operative communication with fluid delivery system 60 and configured to open valve 63 when the amount of liquid solution 61 present in container 62 is below a threshold level. When sensing device 82 senses that the liquid solution is below the threshold level, sensing device 82 permits the fluid to flow from system 60 and be delivered to nozzle 26 dissolving chemical block 20 as previously discussed. This produces additional liquid solution that collects in container 62. Once the amount of collected liquid solution 61 is sufficient to raise the level of the liquid solution in the container above the threshold level, sensing device 82 is configured to close valve 63. The sensing device may be an electrical or a mechanical device.

In an embodiment, sensing device 82 is a mechanical device having a float 84 floating upon the surface of liquid solution 61 as shown in FIG. 1. Float 84 is connected to an arm 86 pivotally attached to valve 63. As liquid solution 61 is discharged through outlet port 72, the level of the liquid solution in container 62 decreases. Once this level falls below a threshold level, the pivoting motion imparted by arm 86 is sufficient to open valve 63 until enough liquid solution is replenished into container 62 to raise float 84 above the threshold level to close valve 63. Either or both detection device 78 or sensing device 82 may be actuated by a controller 88 that may be placed in operative communication with each device and fluid delivery system 60 as is commonly known in the art.

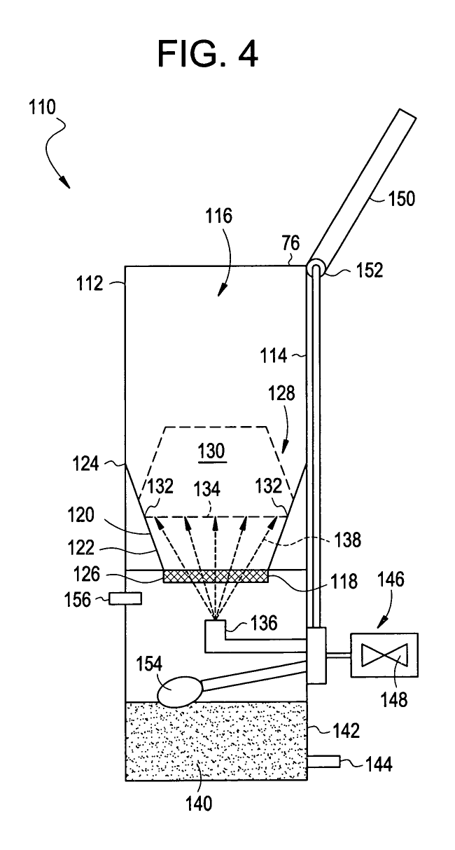

In an embodiment of the present invention, a vessel 110 for dispensing a chemical solution is provided as shown in FIG. 4. Vessel 110 includes a housing 112 having an inner surface 114 that defines a chamber 116. Housing 112 may be cylindrical in shape and substantially vertically disposed as previously discussed. A support member or screen 118 may be permanently or removably mounted substantially horizontally within inner chamber 116.

In FIG. 4, there is an optional overflow port 156 depicted which is designed to allow for drainage of solution in the event of a valve failure causing solution to remain in the vessel instead of leaving the vessel through outlet port 144 as designed.

A sleeve 120 having a tapered wall 122 is disposed in inner chamber 116 above screen 118. An upper end 124 of sleeve 120 contacts inner surface 114 and may or may not be secured to inner surface 114. A lower end 126 connects to screen 118 and may or may not be secured to screen 118. Thus, screen 118 may be secured to inner surface 114 or to lower end 126 as desired. Alternatively, lower end 126 may not be attached to any structure. Tapered wall 122 may extend from inner surface 114 radially inward toward an interior portion of chamber 116. Tapered wall 122 thereby forms a passageway 128 from upper end 124 to lower end 126 having a graduated or otherwise variable diameter. The diameter of passageway 128 at upper end 124 is greater than the diameter of the passageway at lower end 126. The diameter of passageway 128 decreases from upper end 124 to lower end 126 in a substantially uniform manner providing sleeve 120 with a generally frustoconical shape as shown in FIG. 4.

A solid chemical block 130 is placed within chamber 116 and proceeds to enter passageway 128 at upper end 124. Chemical block 130 is depicted as having a generally trapezoidal longitudinal cross-sectional shape as shown in FIG. 4. Other possible configurations for chemical block 130 include anything stackable, such as, but not limited to, truncated cones, prismatic cylinders, spheres, cubes and discs.

With whatever shape for chemical block 130 that is chosen, it is understood that upper end 124 has a diameter greater than the largest diameter of chemical block 130 and lower end 126 has a diameter less than the largest diameter of the chemical block. Chemical block 130 may be placed into chamber 116 so that an outermost peripheral edge 132 is the first portion of the block to enter passageway 128. Chemical block 130 continues through passageway 128 until the diameter of passageway 128 substantially equals or is slightly less than the diameter of chemical block 130 along outermost peripheral edge 132. At this point in passageway 128, outermost peripheral edge 132 comes into supportive contact with the inner surface of tapered wall 122. Thus, chemical block 130 is in supportive contact with tapered wall 122 along substantially the entire perimeter of outermost peripheral edge 132. This arrangement exposes substantially the entire area of a bottom surface 134 of chemical block 130.

A spray member or nozzle 136 located in a lower portion of vessel 110 is positioned below screen 118 in order to upwardly deliver a substantially uniform fluid spray 138 through screen 118 into sleeve 120. Fluid spray 138 impinges bottom surface 134 of chemical block 130 thereby dissolving the block as previously described. The dissolution of chemical block 130 forms a liquid solution 140 containing the dissolved chemical. Liquid solution 140 drips through screen 118 and collects in a container 142 positioned under screen 118.

As chemical block 130 dissolves along the bottom surface, the outermost peripheral edge also dissolves. As this occurs, the weight of block 130 moves the block downward through passageway 128 and continues to push a lowermost perimeter of the block into supportive contact with the inner surface of tapered wall 122. This advantageously produces a chemical dispensing device whereby the exposed area of the chemical block bottom surface is substantially uniform or otherwise constant throughout the life of block 130. Provision of a substantially uniform bottom surface exposure to the spray pattern of fluid spray 138 ensures that the amount of chemical delivered to container 142 with each spray application is substantially constant. When block 130 is dissolved to a point whereby the block is no longer large enough to be supported by tapered wall 122, the block is retained by screen 118 until completely dissolved.

A plurality of chemical blocks in a stacked or otherwise substantially vertical arrangement may be placed within sleeve 120. The outermost peripheral edge of a lowermost block may come into supportive contact with the inner surface of tapered wall 122 to support plurality of blocks. As the lowermost block dissolves upon contact with the fluid spray, the weight of the plurality of blocks moves the lowermost block downward through the sleeve and eventually onto screen 118. Once the lowermost block is no longer supported by tapered wall 122, the peripheral edge of the next block in the vertical arrangement comes into supportive contact with the inner surface of tapered wall 122.

Container 142 may include an outlet port 144 to place vessel 110 in fluid communication with an industrial water system. Vessel 110 may be moveable as previously discussed.

Vessel 110 also includes a fluid delivery system 146 in fluid communication with nozzle 136 for delivering a fluid thereto. Fluid delivery system 146 includes a valve 148 and a fluid source a previously discussed. Fluid delivery system 146 may deliver tap water at ambient temperature to nozzle 136.

Vessel 110 may also include a cover 150 and a detection system 152 operatively connected to cover 150 and fluid delivery system 146. A sensing system 154 in operative communication with the liquid solution in container 142 and fluid delivery system 146 may also be provided to sense the level of liquid solution present in container 142 and configure or otherwise direct fluid delivery system 146 to deliver fluid when the level of the liquid solution falls below a threshold level as previously discussed. Vessel 110 may include an overflow port 156 as a safety feature.

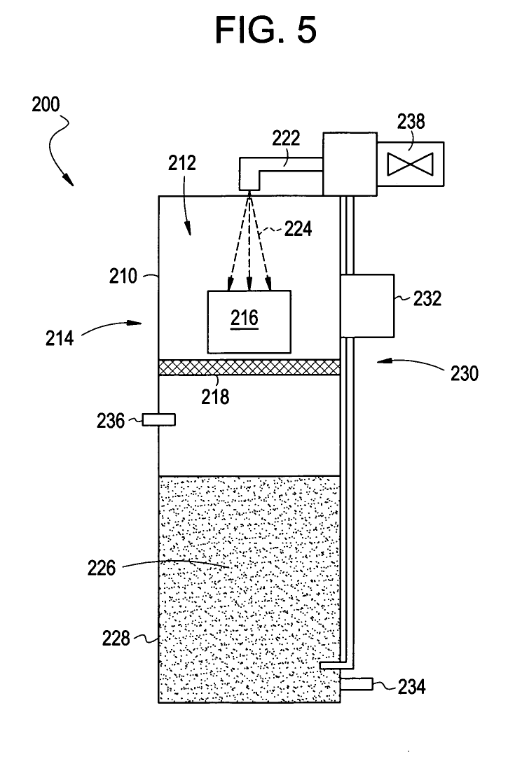

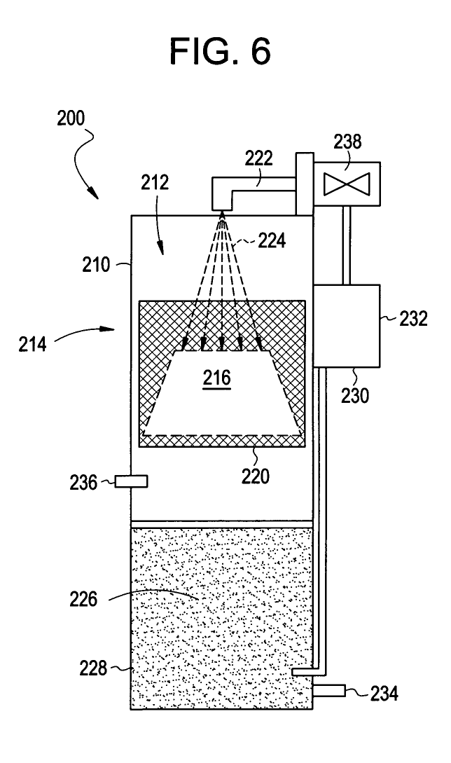

In an embodiment of the present invention, FIGS. 5 and 6 depict a device 200 for producing a chemical solution from a solid chemical block. Device 200 includes a housing 210 defining an inner chamber 212. A porous support member 214 supports one or more solid chemical blocks 216 within chamber 212. Support member 214 may be a flat screen 218 as shown in FIG. 5. Alternatively, support member 214 may be a screen basket 220 as shown in FIG. 6. Screen 218 and/or screen basket 220 may also support a plurality of blocks.

A fluid inlet 222 is disposed above chemical block 216 and introduces a fluid 224 onto chemical block 216. Fluid inlet 222 is in fluid communication with a fluid source and may include valve 238 to control or otherwise regulate the flow of fluid 224 into chamber 212. Positioned above the chemical block, fluid inlet 222 may introduce fluid 224 in a pouring manner, the fluid flowing merely by the force of gravity. Alternatively, fluid inlet 224 may be a spray member, such as a nozzle, for example, to introduce fluid 224 as a spray or a pressurized spray. Fluid 224 may be tap water from a municipal water supply, the fluid being at ambient temperature as previously discussed.

Upon contact with chemical block 216, fluid 224 forms a liquid solution 226 which falls as droplets through porous support member 214 and collects in a container 228. A sensing device 230 for sensing the amount of liquid solution present in container 228 is in operative communication with fluid inlet 222. Sensing device 230 may be any device that can sense or otherwise detect the amount or the level of liquid solution 226 in container 228 as is commonly known in the art. Consequently, sensing device 230 may be a mechanical device, an optical device, or a weight, volume, or liquid detecting device and may or may not be in fluid communication with liquid solution 226. Thus, sensing device 230 may be in mechanical, electrical, or optical communication with fluid inlet 222 as is commonly known in the art.

Sensing device 230 directs fluid inlet 222 to introduce the fluid when the amount of liquid solution in the container is below a threshold level. For example, sensing device 230 may be a floatation arm-type device in fluid communication with liquid solution 226 and in mechanical communication with a valve 238 of fluid inlet 222. When the level of the liquid solution is below the threshold level, the torque imposed on the fluid inlet valve by the floatation device opens valve 238 as previously discussed.

Alternatively, sensing device 230 may generate a signal when the level of liquid solution 226 is below the threshold level. Fluid inlet 222 may be configured to respond to the signal and introduce fluid 224 into chamber 212 in response to the signal. For example, sensing device 230 may generate an electronic signal when the liquid solution level is below the threshold level. Fluid inlet 222 may be configured with an electronically actuated solenoid that may open the valve to introduce fluid in response to the electronic signal generated by sensing device 230. Sensing device 230 may generate an optical signal and fluid inlet 222 may be configured to receive and respond to the optical signal in order to introduce fluid 224 into chamber 212 in a similar manner.

Device 200 may be configured with a controller 232 to regulate the amount of fluid introduced into chamber 212. Controller 232 may be used to ensure that a uniform or constant amount of fluid is introduced into chamber 212 each time sensing device 230 directs fluid inlet 222 to open. Controller 232 may be a water meter that measures the amount of fluid flowing through fluid inlet 222 or valve 238. The water meter may open fluid inlet 222 to allow a predetermined amount of fluid to be introduced into chamber 212. Alternatively, controller 232 may be a timer that opens fluid inlet 222 for a predetermined amount of time. Provided the flow rate of fluid inlet 222 is constant, opening the fluid inlet for a predetermined time will also introduce a uniform amount of fluid into chamber 212 each time fluid inlet 22 is opened.

Device 200 may be a self-contained unit making device 200 moveable or otherwise portable. Container 228 may be equipped with an outlet port 234 enabling device 200 to be placed in fluid communication with an industrial water system. Container 228 may be further equipped with an overflow outlet 236.

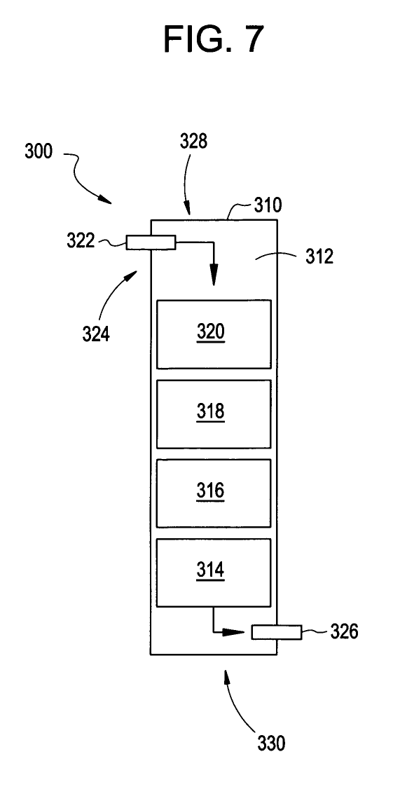

FIG. 7 shows a device 300 for producing a chemical solution in accordance with another embodiment of the present invention. Device 300 includes a housing 310 defining a chamber 312. A plurality of solid chemical blocks 314, 316, 318, and 320 are disposed within chamber 312. Although FIG. 7 show four blocks, it will be appreciated that chamber 312 may be configured to hold as few as one and as many as 10 or more blocks.

A fluid inlet 322 for introducing a fluid into chamber 312 is disposed on an inlet side 324 of housing 310. Fluid inlet 322 may or may not be attached to housing 310. The fluid may be water from a municipal water supply, the fluid being at ambient temperature, such as tap water, for example.

A fluid inlet 322 may introduce the fluid into chamber 312 under the force of gravity in a pouring or flowing manner. The fluid may be introduced continuously at a low flow rate such as a trickle, for example. The fluid may also be introduced intermittently or non-continuously at any desired flow rate. Alternatively, the fluid may be introduced as a spray with a spray member such as a nozzle, for example. At least a portion of the plurality of blocks 314, 316, 318, and 320 dissolve when contacted with the fluid to form a liquid solution. In an embodiment, at least two blocks dissolve substantially contemporaneously from contact with the fluid to form the liquid solution. It is understood that device 300 may be configured so that one, some or all of blocks 314, 316, 318, and 320 are contacted by the fluid. FIG. 7 shows blocks 314, 316, 318, and 320 in a substantially vertically stacked arrangement. Fluid inlet 322 is located above this stack to introduce the fluid upon the entire stack so that the fluid contacts each block. Alternatively, blocks 314, 316, 318, and 320 may be horizontally arranged in a non-stacked manner within chamber 312.

An outlet member 326 is in fluid communication with chamber 312 for discharging the liquid solution from the chamber. Outlet member 312 may be positioned on an end opposing inlet side 324 providing a flow-through arrangement. The flow-through arrangement introduces the fluid on a first side and a first end of device 300 and discharges the fluid from a second side opposing the first side and a second end opposing the first end. The fluid thereby flows through substantially the entire length of housing 310. This arrangement ensures that a significant amount of the chemical is dissolved in the liquid solution exiting through outlet member 326. The liquid solution leaving outlet member 326 can be saturated with the chemical or chemicals of the chemical blocks 314, 316, 318, and 320. Fluid inlet 322 can be disposed on an upper end 328 of housing 310 and outlet member 326 positioned on an opposing lower end 330 of housing 310. Alternatively, fluid inlet 322 and outlet member 326 may be positioned relative to each other so that only a portion of the plurality of blocks are contacted with the fluid.

Outlet member 326 may be placed in fluid communication with an industrial water system. Device 300 is well suited to treat low demand water systems. The fluid forces necessary for the operation of device 300 are gravity-driven eliminating the need for a power supply. In addition, fluid inlet 322 may be configured to provide a substantially continuous or non-continuous flow of fluid as desired. The use of ambient tap water reduces the need for any water pretreatments or temperature control systems. Device 300 may be a stand-alone unit and moveable. Consequently, device 300 provides a simple, exceptionally low maintenance device for chemically treating a water system selected from the group comprising institutional water systems and industrial water systems.

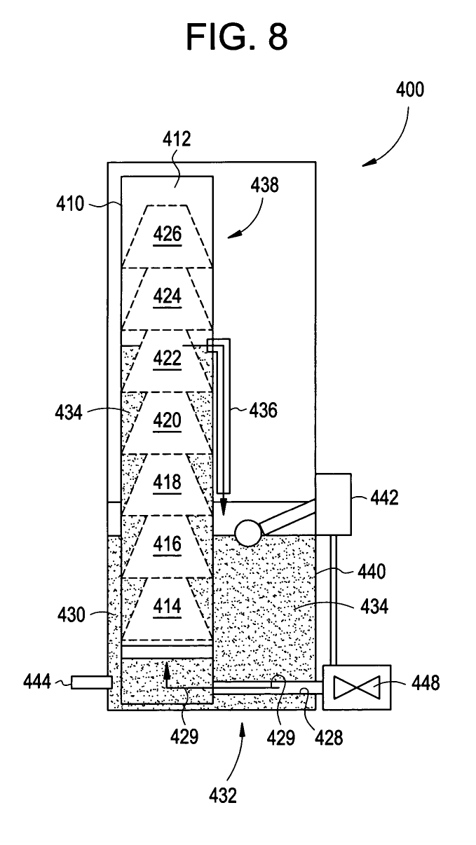

FIG. 8 depicts a device 400 for producing a chemical solution from a solid chemical block in accordance with another embodiment of the present invention. Device 400 includes a housing 410 having a chamber 412. Housing 410 separates chamber 412 from solution 434.

Solid chemical blocks 414, 416, 418, 420, 422, 424, 426, are disposed in chamber 412. FIG. 8 shows the blocks stacked or in a substantially vertical arrangement although the blocks may be disposed in chamber 412 substantially horizontally or in a plurality of vertical stacks without detracting from the scope of the present invention. The number of chemical blocks may range from one to about ten, twenty or more. The chemical blocks may be supported by a porous support member or flat screen 430. Alternatively, the blocks may be supported by an inner surface of chamber 412.

A fluid inlet 428 introduces a fluid 429 into chamber 412 at end 432. Fluid inlet 428 may be in fluid communication with a municipal water supply that provides tap water at ambient temperature to the fluid inlet. Fluid inlet 412 introduces the fluid at end 432 to contact and dissolve at least a portion of one or more of blocks 414-428 to form a liquid solution 434.

A fluid outlet 436 is positioned at opposing end 438 that is opposite to end 432 for discharging liquid solution 434 from chamber 412 and into a container 440. In an embodiment, end 432 is a lower end of the chamber and opposite end 438 is an upper end of the chamber. This low-inlet, high-outlet arrangement provides a counterflow through chamber 412. In other words, the fluid and/or liquid solution 434 flows through chamber 412 against the force of gravity to form a fluid counterflow through chamber 412. The fluid flows upward from fluid inlet 428 through chamber 412 in order to exit the chamber through fluid outlet 436. This counterflow arrangement ensures that liquid solution 434 is saturated or nearly saturated with the chemical or chemicals from the blocks. The fluid may be introduced into chamber 412 continuously or intermittently as desired.

As the blocks in contact with liquid solution 434 dissolve, blocks higher in the stack eventually descend into the liquid solution. At least one block, such as blocks 424 and 426, may not be in contact with liquid solution 434. This provides an internal supply of blocks directly within chamber 412 for future use thereby reducing the amount of maintenance required to operate device 400. Fluid outlet 436 may be positioned anywhere along the vertical length of housing 410 to set the immersion level for blocks 414-426 as desired.

Device 400 may include a sensing device 442 for sensing the amount of liquid solution present in container 440. Sensing device 442 is in operative communication with a valve 448. Sensing device 442 may configure valve 448 to open or otherwise introduce the fluid when the amount of liquid solution 434 in container 440 is below a threshold level. Sensing device 442 may be operatively connected to valve 448 mechanically, electrically, or optically in order to control the flow of fluid into the fluid inlet 428 as previously discussed.

Container 440 may include an outlet port 444 that may be in fluid communication with an industrial water system in order to dispense liquid solution 434 thereto. Device 400 may be a self-contained unit making device 400 moveable or otherwise portable.

The solid chemical block of the present invention may be a water treatment formulation delivered into the water of an institutional water system or an industrial water system as is commonly known in the art. An advantage of the solid chemical block of the present invention is its ability to readily dissolve when contacted by tap water at ambient temperature.

In an embodiment, the solid chemical block includes an inert fluorescent tracer in a known proportion. The presence of the inert fluorescent tracer in the liquid solution dispensed from any of the herein described vessels or devices allows the liquid solution to be monitored and evaluated while in an institutional water system or an industrial water system. A fluorometer may be used to monitor the fluorescent signal of the inert fluorescent chemical from the dispensed liquid solution. This technology is commercially available as TRASAR®, which is a registered trademark of Nalco Company, 1601 W. Diehl Road, Naperville Ill. 60563, ((630) 305-1000). See U.S. Pat. No. 6,685,840, METHOD FOR DETERMINING THE DISSOLUTION RATE OF A SOLID WATER TREATMENT PRODUCT, issued on Feb. 3, 2004 and incorporated by reference in its entirety.

The fluorescent signal of the inert fluorescent chemical is used to determine how much inert fluorescent tracer is present, and by knowing the amount of inert fluorescent tracer that is present it is possible to determine the amount of treatment product that is present in the industrial system. If the amount of treatment product that is present is not what is desired then the feed rate of treatment product can be adjusted to provide the desired amount of treatment product.

In another embodiment of the present invention, the solid chemical block of the present invention is a composition for treating water having a matrix component, a compacting component, a corrosion inhibiting agent, a yellow metal corrosion inhibitor, and a tracing agent. The composition readily dissolves when contacted with water at ambient temperature.

The matrix component may be a water soluble component suitable to suspend the water active components in the composition. The matrix component may be a polyethylene glycol, with a melting point above 50° C., having an weight average molecular weight from about 2500 to about 20,000 with a polyethylene glycol having an average molecular weight of about 4600 being most preferred. The matrix component may be present from about 34% to about 56% by weight of the composition. In an embodiment, the matrix component is Carbowax 4600™ available from The Dow Chemical Company, Midland Mich.

The compacting component complements the matrix component and condenses the composition. The compacting component reduces the volume and increases the density of the composition. The compacting component may be urea, which is commercially available. In an embodiment, the compacting component may be present from about 3% to about 7.5% by weight of the composition.

The corrosion inhibiting agent may be a combination of a calcium carbonate stabilizer and a steel corrosion inhibitor as is commonly known in the art. The corrosion inhibiting agent may be selected from the group consisting of 1-hydroxyethan-1,1-diphosphonic acid and phosphonosuccinate oligomer. In an embodiment, the corrosion inhibiting agent is present from about 14% to about 35% by weight of the composition.

The yellow metal corrosion inhibitor may be selected from the group consisting of benzotriazole, tolyltriazole and halogenated tolyltriazole. The yellow metal corrosion inhibitor may be present from about 2% to about 15% by weight of the composition. Benzotriazole is preferred.

In an embodiment, the tracing agent may be selected from the group consisting of pyrene tetrasulphonic acid sodium salt, 1,3,6,8-pyrenetetrasulfonic acid sodium salt, fluorescein, molybdate, vanadate and naphthalene disulfonic acid, sodium salt. In an embodiment, the tracing agent is present from about 0.15% to about 1.1% by of the composition. It is preferred that pyrene tetrasulphonic acid, sodium salt is the tracing agent.

The composition of the present invention may further include a dispersant, the dispersant being selected from the group consisting of amine substituted sulfomethylated acrylamide acrylate terpolymer, polyacrylate, sulfonated styrene maleic anhydride, and sulfomethylated acrylamide acrylate terpolymers, including without being limited to tagged sulfomethylated acrylamide/acrylic acid, partial sodium salt, terpolymer. The dispersant may be present from about 9% to about 42% by weight of the composition. In an embodiment, the dispersant is sulfomethylated acrylamide acrylate terpolymer also known as tagged sulfomethylated acrylamide/acrylic acid, partial sodium salt, terpolymer.

The composition of the present invention may also include a scale inhibiting agent. The scale inhibiting agent may be selected from the group consisting of 2-phosphonobutane-1,2,4-tricarboxylic acid tetra sodium salt, 1-hydroxyethylidene-1,1-diphosphonic acid, and aminotrimethylene phosphonate. In an embodiment, the scale inhibiting agent is present from about 14% to about 16% by weight of the composition. Preferably, the scale inhibitor is 2-phosphonobutane-1,2,4-tricarboxylic acid tetra sodium salt.

The following formulations have been found to be formable into the chemical blocks found to be useful in the instant claimed invention.

Weight % of Block

Soft Water Program I

| | |
|---|---|
| Carbowax 4600 | 41-45% |
| Urea | 4-6% |
| 1-hydroxyethan-1,1-disphosphonic acid | 18-20% |
| Sodium molybdate dihydrate | 14-16% |
| Benzotriazole | 2-4% |
| Dispersant polymer | 13-15% |
| Pyrene tetrasulphonic acid, sodium salt | 0.2-0.35% |

% of Block

Soft Water Program II

| | |
|---|---|
| Carbowax 4600 | 38-42% |
| Urea | 3-4.5% |
| Phosphonosuccinate oligomer | 30-35% |
| Sodium orthophosphate | 10-12% |
| Benzotriazole | 2-4% |
| Dispersant polymer | 9-11% |
| Pyrene tetrasulphonic acid, sodium salt | 0.15-0.3% |

All-Organic I

| | |
|---|---|
| Carbowax 4600 | 53-56% |
| Urea | 5.5-7.5% |
| 1-hydroxyethan-1,1-disphosphonic acid | 21-24% |
| Benzotriazole | 13-16% |
| Pyrene tetrasulphonic acid, sodium salt | 0.9-1.1% |

All-Organic II

| | |
|---|---|
| Carbowax 4600 | 34-38% |
| Urea | 3-5% |
| 1-hydroxyethan-1,1-disphosphonic acid | 11-13% |
| Benzotriazole | 7.5-9% |
| Polymer | 38.5-40.5% |
| Pyrene tetrasulphonic acid, sodium salt | 0.3-0.5% |

All-Organic III

| | |
|---|---|
| Carbowax 4600 | 39-41% |
| Urea | 4-6% |
| 2-phosphonobutane-1,2,4-tricarboxylic acid | 14-16% |
| tetra sodium salt | |
| 1-hydroxyethan-1,1-disphosphonic acid | 14-16% |
| Benzotriazole | 2-3% |
| Polymer | 21-23% |
| Pyrene tetrasulphonic acid, sodium salt | 0.2-0.4% |

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A vessel for dispensing a chemical solution from a solid chemical block, comprising:
an inner surface defining a chamber;
a plurality of spaced apart guide members disposed along the inner surface for positioning at least one chemical block to form a gap between the inner surface and a circumference of the block;
a porous support member for supporting the at least one chemical block in the chamber; and
a spray member located below the support member for directing a spray in an upward manner along at least a portion of a vertical length of the chamber, the spray contacting a surface of the block to form a liquid solution.

2. The vessel of claim 1 wherein the vessel is moveable.

3. The vessel of claim 1 further comprising a lower section for receiving the liquid solution.

4. The vessel of claim 1 wherein the vessel is in fluid communication with a water system selected from the group comprising an institutional water system and an industrial water system.

5. The vessel of claim 1 wherein a portion of the fluid spray impinges the inner surface before contacting the block surface.

6. The vessel of claim 1 wherein a portion of the fluid spray impinges the plurality of guide members before contacting the block surface.

7. The vessel of claim 1 wherein the fluid spray contacts a bottom surface and a side surface of the block.

8. The vessel of claim 1 further comprising a plurality of chemical blocks in a substantially vertical arrangement disposed between the plurality of guide members.

9. The vessel of claim 8 wherein a portion of the fluid spray contacts a surface of a second block.

10. The vessel of claim 9 wherein a portion of the fluid spray contacts the inner surface of the chamber before contacting the surface of the second block.

11. The vessel of claim 1 wherein the porous support member is a screen.

12. The vessel of claim 1 wherein the temperature of the spray is ambient temperature.

13. The vessel of claim 1 further comprising:
a cover pivotally attached to an upper end of the housing, the cover moveable between an open position and a closed position; and
a detection device for detecting the position of the cover, the detection device in operative communication with a fluid source in fluid communication with the spray member, the detection device configured to prevent delivery of the fluid to the spray member when the cover is in the open position.

14. The vessel of claim 1 further comprising:
a sensing device for sensing the amount of liquid solution present in the container, the sensing device in operative communication with the a fluid source in fluid communication with the spray member, the sensing device configured to open the fluid source when the amount of the liquid solution is below a threshold level in the container.

15. A vessel for dispensing a chemical solution from a solid chemical block, comprising:
an inner surface defining a chamber;
an annular sleeve having a tapered wall;
at least one chemical block having a peripheral edge in supportive contact with an inner surface of the tapered wall to expose a surface of the block;
a spray member located below the sleeve for directing a spray in an upward manner along a vertical length of the sleeve, the spray contacting a surface of the block to form a liquid solution, the tapered wall extending from the inner surface toward the spray member.

16. The vessel of claim 15 wherein a bottom surface of the block is exposed to the spray member.

17. The vessel of claim 15 wherein the area of the exposed bottom surface remains substantially uniform as the spray contacts the bottom surface.

18. The vessel of claim 15 wherein the spray member directs a substantially uniform fluid spray onto the block.

19. The vessel of claim 15 further comprising a container for receiving the liquid solution.

20. The vessel of claim 15 wherein the vessel is moveable.

21. The vessel of claim 15 wherein the temperature of the spray is ambient temperature.

22. The vessel of claim 15 further comprising a plurality of chemical blocks stacked upon each other, a lowermost block having a peripheral edge in supportive contact with the inner surface of the tapered wall.

23. The vessel of claim 15 wherein the vessel is in fluid communication with a water system selected from the group comprising an institutional water system and an industrial water system.

24. The vessel of claim 15 further comprising:
a cover pivotally attached to an upper end of the housing, the cover moveable between an open position and a closed position; and
a detection device for detecting the position of the cover, the detection device in operative communication with a fluid source in fluid communication with the spray member, the detection device configured to prevent delivery of the fluid to the spray member when the cover is in the open position.

25. The system of claim 15 further comprising:
a sensing device for sensing the amount of liquid solution present in the container, the sensing device in operative communication with the a fluid source in fluid communication with the spray member, the sensing device configured to open the fluid source when the amount of the liquid solution is below a threshold level in the container.

26. A device for producing a chemical solution from a solid chemical block comprising:
a housing having an inner chamber;
a porous support member within the housing for supporting the chemical block within the inner chamber;
a fluid inlet for introducing a fluid into the chamber, the fluid dissolving at least a portion of the chemical block to form a liquid solution;
a container for receiving the liquid solution; and
a sensing device for sensing the amount of liquid solution present in the container, the sensing device in operative communication with the fluid inlet, the sensing device configuring the fluid inlet to introduce the fluid when the amount of liquid solution in the container is below a threshold level.

27. The device of claim 26 wherein the fluid inlet introduces a predetermined volume of fluid.

28. The device of claim 26 wherein the fluid inlet introduces a fluid for a predetermined amount of time.

29. The device of claim 26 wherein the porous support member is selected from the group consisting of a screen and a screen basket.

30. The device of claim 26 further comprising a plurality of chemical blocks.

31. The device of claim 26 wherein the device is moveable.

32. The device of claim 26 wherein the temperature of the fluid is ambient temperature.

33. The device of claim 26 wherein the container is in fluid communication with a water system selected from the group comprising an institutional water system and an industrial water system.

34. A device for producing a chemical solution comprising:
a housing defining a chamber;
a plurality of solid chemical blocks disposed within the chamber;
a fluid inlet for introducing a fluid into the chamber, at least two or more blocks dissolving substantially contemporaneous from contact with the fluid to form a liquid solution; and
an outlet member in fluid communication with the chamber for discharging the liquid solution from the chamber.

35. The device of claim 34 wherein the fluid inlet is on an inlet side of the housing and the outlet member is on an opposing side of the housing.

36. The device of claim 35 wherein the fluid inlet is on an upper end of the housing.

37. The device of claim 34 wherein the plurality of blocks are disposed in a substantially vertically stacked arrangement.

38. The device of claim 34 wherein the fluid is water at ambient temperature.

39. The system of claim 34 wherein the outlet member is in fluid communication with a water system selected from the group comprising an institutional water system and an industrial water system.

40. The device of claim 34 wherein the device is moveable.

41. A device for producing a chemical solution from a solid chemical block comprising:
a housing having a chamber;
a solid chemical block disposed within the chamber;
a fluid inlet for introducing a fluid into a first end of the chamber, the fluid contacting the chemical block to dissolve at least a portion of the block to form a liquid solution; and
a fluid outlet at an opposite end of the first end for forming a fluid counterflow through the chamber.

42. The device of claim 41 wherein the first end is a lower end of the chamber and the opposite end is an upper end of the chamber.

43. The device of claim 41 further comprising a plurality of chemical blocks in a substantially vertical arrangement disposed in the chamber.

44. The device of claim 41 wherein at least one block is not contacted by the fluid.

45. The device of claim 41 further comprising a container for receiving the liquid solution from the fluid outlet and a sensing device for sensing the amount of liquid solution present in the container, the sensing device in operative communication with the fluid inlet, the sensing device configuring the fluid inlet to introduce the fluid when the amount of liquid solution in the container is below a threshold level.

46. The device of claim 41 wherein the temperature of the fluid is ambient temperature.

47. The device of claim 41 wherein the device is moveable.

48. The device system of claim 41 wherein the outlet member is in fluid communication with an industrial water system.

49. A facility comprising:
a vessel having an inner surface defining an inner chamber, a plurality of spaced apart guide members disposed along an inner surface of the chamber for positioning at least one chemical block to form a gap between the inner surface and a circumference of the block, a porous support member for supporting the at least one chemical block in the chamber, and a spray member located below the support member for directing a spray in an upward manner along a vertical length of the inner chamber, the spray contacting a surface of the block to form a liquid solution; and
a water system in fluid communication with the vessel,
wherein the facility is selected from the group comprising an institutional facility and an industrial facility and the water system is selected from the group comprising an institutional facility and an industrial facility.

50. The facility of claim 49 wherein the facility is an industrial facility and the water system is an industrial water system selected from the group consisting of cooling water systems, open recirculating cooling water systems, closed cooling water systems, once-through cooling water systems, boilers, boiler water systems, petroleum well water systems, downhole formations, geothermal wells, oil field water systems, mineral washing systems, flotation water systems, benefaction water systems, paper mill digesters, washers, bleach plants, white water systems, black liquor evaporators, gas scrubbers, air washers, metallurgical continuous casting processes, air conditioning systems, refrigeration systems, industrial process water systems, petroleum process water systems, indirect contact cooling systems, indirect contact heating water systems, pasteurization water systems, water reclamation and purification systems, membrane filtration water systems, food processing systems and waste treatment systems.

51. The facility of claim 49 wherein the facility is an institutional facility selected from the group consisting of hotels, hospitals, health care facilities, nursing homes, educational campuses, decorative fountains, bathing ponds, whirpool baths, swimming pools, water parks and theme park amusement facilities requiring large amounts of non-potable water and other recreational facilities and the water system is an institutional water system.

52. A method of dispensing a solid water treatment product into an water system, comprising:
providing a housing having at least two solid chemical blocks containing the water treatment product disposed therein;
introducing a fluid into the housing;
contacting the at least two chemical blocks with the fluid to dissolve contemporaneously at least a portion of each of the at least two chemical blocks to form a liquid solution containing the water treatment product; and
dispensing the liquid solution into the industrial water system, wherein the water system is selected from the group comprising an institutional water system and an industrial water system.

53. The method of claim 52 wherein the housing has an inner surface defining a chamber, the method further comprising:
providing a plurality of spaced apart guide members along the inner surface;
positioning the chemical blocks between the guide members to form a gap between the inner surface a circumference of the block;
supporting with a porous support member the solid chemical block within the chamber; and
directing a spray of the fluid from under the block into the chamber.

54. The method of claim 52 further comprising impinging a portion of the spray upon the inner surface before contacting the block.

55. The method of claim 52 further comprising impinging a portion of the fluid spray upon at least one of the plurality of guide members before contacting the block.

56. The method of claim 52 further comprising contacting with the spray a side surface and a bottom surface of the block.

57. The method of claim 52 wherein the housing has an inner surface defining an inner chamber, the method further comprising:
providing an annular sleeve having a tapered wall;
supporting a peripheral edge of at least one of the blocks with an inner surface of the tapered wall to expose a surface of the block; and
directing a spray of the fluid from under the block into the sleeve.

58. The method of claim 52 further comprising exposing to the spray a substantially uniform area of a bottom surface of the block as the block dissolves.

59. A composition for treating water comprising:
(a) a matrix component, wherein the matrix component is a polyethylene glycol having an weight average molecular weight from about 2500 to about 20,000, and wherein the matrix component is present from about 34% to about 56% by weight of the composition,
(b) a compacting component; wherein the compacting component is urea, and wherein the compacting component is present from about 3% to about 7.5% by weight of the composition;
(c) a corrosion inhibiting agent selected from the group consisting of 1-hydroxyethan-1,1-diphosphonic acid and phosphonosuccinate oligomer, wherein the corrosion inhibiting agent is present from about 14% to about 35% by weight of the composition;
(d) a yellow metal corrosion inhibitor selected from the group consisting of benzotriazole, tolyltriazole and halogenated tolyltriazole, and wherein said yellow metal corrosion inhibitor is present from about 2% to about 15% by weight of the composition; and
(e) a tracing agent selected from the group comprising pyrene tetrasulphonic acid sodium salt, 1,3,6,8-pyrenetetrasulfonic acid sodium salt, fluorescein, molybdate, vanadate and naphthalene disulfonic acid, sodium salt, wherein said tracing agent is present from about 0.15% to about 1.1% by weight of the composition.

60. The composition of claim 59 further comprising a dispersant, wherein the dispersant is selected from the group consisting of amine substituted sulfomethylated acrylamide acrylate terpolymer, polyacrylate, sulfonated styrene maleic anhydride, and sulfomethylated acrylamide acrylate terpolymers, including a tagged sulfomethylated acrylamide/acrylic acid, partial sodium salt, terpolymer, and the dispersant is present from about 9% to about 42% by weight of the composition.

61. The composition of claim 59 further comprising a scale inhibiting agent, wherein the scale inhibiting agent is selected from the group consisting of 2-phosphonobutane-1,2,4-tricarboxylic acid tetra sodium salt, 1-hydroxyethylidene-1,1-diphosphonic acid, and aminotrimethylene phosphonate and wherein the scale inhibiting agent is present from about 14% to about 16% by weight of the composition.
